(19) United States
(12) Patent Application Publication
(10) Pub. No.: US 2026/0040267 A1
(43) Pub. Date: Feb. 5, 2026

(54) METHOD AND APPARATUS FOR MANAGING A LOCATION REPORTING IN A WIRELESS COMMUNICATION SYSTEM

(71) Applicant: Samsung Electronics Co., Ltd., Suwon-si (KR)

(72) Inventors: Kiran Gurudev Kapale, Bangalore (IN); Arunprasath RAMAMOORTHY, Bangalore (IN)

(21) Appl. No.: 19/284,520

(22) Filed: Jul. 29, 2025

(30) Foreign Application Priority Data
Jul. 31, 2024 (IN) 202441058090
Jul. 14, 2025 (IN) 202441058090

(51) Int. Cl. H04W 64/00; H04W 4/90; H04W 12/06

(52) U.S. Cl. CPC H04W 64/00; H04W 4/90; H04W 12/06

(57) ABSTRACT

The disclosure relates to a 5G or 6G communication system for supporting a higher data transmission rate. The method includes an authorized MC service user using a location management client to cancel requested location reporting triggers for the location information of another MC service user. The request can be used to cancel its own or another MC service user's requested location reporting triggers. A first location management client residing on a first MC service UE can transmit a location reporting trigger to a location management server to obtain location information of an MC service user at a second location management client residing at a second MC service user. The first location management client determines that the location information of the MC service user at the second location management client is unnecessary and transmits a location reporting trigger update or location reporting trigger cancel request to the location management server.

### CROSS-REFERENCE TO RELATED APPLICATIONS

This application is based on and claims priority under 35 U.S.C. § 119 to Indian Patent Application No. 202441058090 filed on Jul. 31, 2024, and Indian Patent Application No. 202441058090, filed Jul. 14, 2025, in the Indian Intellectual Property Office, the disclosures of which are incorporated by reference herein in their entirety.

### BACKGROUND

### 1. Field

This application claims the benefit of priority to Indian Provisional Application No. 202441058090, filed on Jul. 31, 2024, the disclosure of which is hereby incorporated by reference in its entirety. The present disclosure relates generally to the field of wireless communication. More particularly, the disclosure pertains to a method and system for managing location reporting in a wireless communication network.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Mission-critical (MC) services are essential for public safety communities, including police, military, fire services, ambulance crews, and other emergency responders. These services demand high reliability, speed, quick accessibility, and low latency to ensure effective operational support. A critical aspect of these operations is the management of location information among MC service users, which involves the use of location management clients and servers.

The location information of an MC service user is provided by the location management client to the location management server. This information is reported based on a location reporting configuration, which includes location reporting triggers and the specific location data expected. The location reporting configuration is supplied by the location management server. An authorized MC service user interested in obtaining the location information of another MC service user sends a location reporting trigger from its location management client to the location management server. The server, in turn, may send an initial or updated location reporting configuration to the targeted MC service user's location management client based on the received trigger.

However, challenges arise when an authorized MC service user no longer wishes to receive location information about another MC service user or a functional alias. In such cases, the authorized user may send a location reporting trigger cancel request from its location management client to the location management server. Further, an authorized MC service user can send a cancel request to terminate another MC service user's requested location reporting triggers. Upon receiving the cancel request, the location management server can either cancel or update the location reporting configuration of the targeted MC service users at their location management clients.

The current specifications lack a clear method for canceling location reporting triggers and do not adequately define how the location management server should handle updating or canceling the location reporting configuration of the targeted MC service users at their location management clients. As a result, the location management client of target MC service user continues to report location information based on the triggers provided in the location reporting configuration, even if the authorized MC service user is no longer interested in receiving this information. This limitation leads to inefficiencies and potential information overload.

Thus, it is desired to address the above-mentioned disadvantages, issues or other shortcomings or at least provide a useful alternative.

### SUMMARY

The principal object of the embodiments herein is to provide a system and method for managing location reporting in wireless communication.

Another object of the embodiments herein is to provide a system and method for canceling requested location reporting triggered by an authorized MCX user.

Yet another object of the embodiments herein is to update or cancel the location reporting trigger, triggered by an authorized MCX user to obtain the location information of the second location management client authorized MC service user or one or more functional aliases.

In an aspect, the objects are achieved by providing a method for managing location reporting by a first location management client in wireless communication. The method includes transmitting by a first location management client a location reporting trigger to a location management server to obtain location information of a mission critical (MC) service user at a second location management client. The first location management client resides on a first MC service UE, and the second location management client resides on a second MC service UE. The MC service user at the first location management client determines that the location information of the MC service user at the second location management client is deemed unnecessary. Upon finding that the location information of the MC service user to be unnecessary, the first location management client transmits the location reporting trigger update or location reporting trigger cancel request to the location management server. The second location management client includes a second location management client authorized MC service user or one or more functional aliases.

In another aspect, the objects are achieved by providing a method for managing location reporting by the location management server in wireless communication. The method includes receiving by the location management server the location reporting trigger update or location reporting trigger cancel request from the first location management client to update or cancel the location reporting trigger. The first location management client resides on a first MC service UE. Further, the location management server verifies whether the first location management client is authorized to update or cancel the location reporting trigger request for the second location management client's location information. The location management server initiates the event-triggered location reporting trigger update or cancel for the location information of the second location management client upon receiving the location reporting trigger update or location reporting trigger cancel request from the first location management client.

In yet another aspect, the objects are achieved by providing a first location management client for managing location reporting in wireless communication. The first location management client includes a memory, a processor, and a location reporting triggering controller. The first location management client transmits the location reporting trigger to the location management server to obtain location information of the MC service user at the second location management client. The first location management client resides on the first MC service UE, and the second location management client resides on a second MC service UE. The first location management client determines that the location information of the MC service user at the second location management client is deemed unnecessary and transmits the location reporting trigger update or location reporting trigger cancel request to the location management server.

In yet another aspect, the objects are achieved by providing a location management server for managing location reporting in wireless communication. The location management server receives the location reporting trigger update or location reporting trigger cancel request from the first location management client to update or cancel the location reporting trigger. The first location management client resides on a first MC service UE. Further, the location reporting trigger controller verifies whether the first location management client is authorized to update or cancel the location reporting trigger request for the second client device and determines that the first location management client is authorized to update or cancel the location reporting trigger. Furthermore, the location reporting trigger controller initiates an event-triggered location reporting trigger update or cancel for the second location management client upon receiving the location reporting trigger update or location reporting trigger cancel request from the first location management client device.

The aspects of these embodiments will be better understood with the following description and accompanying drawings. The descriptions, while indicating preferred embodiments and specific details, are for illustration and not limitation. Many changes and modifications can be made within the scope of these embodiments without departing from their spirit, and all such modifications are included.

Aspects of the present disclosure provide efficient communication methods in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The features, aspects, and advantages of the present embodiments are illustrated in the accompanying drawings, where like reference letters indicate corresponding parts across various figures. The embodiments will be better understood from the following description and drawings.

FIG. 1 illustrates hardware features of the first location management client according to the embodiments as disclosed herein.

FIG. 2 illustrates hardware features associated with the second location management client according to the embodiments as disclosed herein.

FIG. 3 illustrates a sequence diagram of the client-triggered location reporting cancel procedure according to embodiments as disclosed herein.

FIG. 4 illustrates a sequence diagram of a method for a periodic location information report cancellation for shared functional alias according to embodiments as disclosed herein.

FIG. 5 illustrates a sequence diagram of a method for a periodic location information report for shared functional alias according to embodiments as disclosed herein.

FIGS. 6 and 7 illustrate flowcharts of the method for reporting a location in a wireless communication system according to the embodiments as disclosed herein.

FIG. 8 illustrates a terminal or UE according to an embodiment of the disclosure.

FIG. 9 illustrates a BS according to an embodiment of the disclosure.

FIG. 10 illustrates a network entity according to an embodiment of the disclosure.

### DETAILED DESCRIPTION

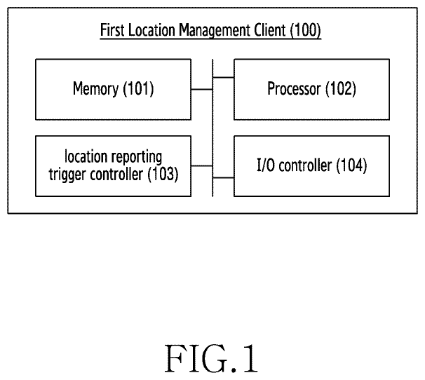

FIG. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

Herein, it will be understood that each block of the flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “˜unit” may refer to a software element or a hardware element, such as a field programmable gate array (FPGA) or an application specific integrated circuit (ASIC), which performs a predetermined function. However, the term including the word “˜unit” does not always have a meaning limited to software or hardware. The “˜unit” may be constructed either to be stored in an addressable storage medium or to execute one or more processors. Therefore, the “˜unit” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “˜unit” may be either combined into a smaller number of components and a “˜unit,” or divided into additional components and a “˜unit.” Moreover, the components and “˜units” may be implemented to reproduce one or more central processing units (CPUs) within a device or a security multimedia card. Further, in the embodiments, the “˜unit” may include one or more processors.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a CPU), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the present disclosure may provide a program comprising code for implementing apparatus or a method as claimed in any one of the claims of this specification and a non-transitory machine-readable storage storing such a program.

Hereinafter, the determination of priority between A and B in the present disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the present disclosure may be understood as “A and/or B,” which may include A, or B, or both A and B.

In addition, “at least one of A, B, and C” as described in the present disclosure may be understood to include A, or B, or C, or any combination of A, B, and C.

In addition, “at least one of A, B, or C” as described in the present disclosure may be understood to include A, or B, or C, or any combination of A, B, and C.

Furthermore, “A/B” as described in the present disclosure may be understood as “A and/or B,” which may include A, or B, or both A and B.

Furthermore, “A, B” as described in the present disclosure may be understood as “A and/or B,” which may include A, or B, or both A and B.

Furthermore, “A and B” as described in the present disclosure may be understood as “A and/or B,” which may include A, or B, or both A and B.

Furthermore, “if condition A and condition B are satisfied,” as described in the present disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used merely to distinguish between different instances, occurrences, configurations, messages, stages, or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first ˜,” “second ˜,” etc., as described in the present disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ˜” and “second ˜” are described in the present disclosure, it may be understood that element(s) referred to by “first ˜” and “second ˜” may be the same or different. For example, in case of element(s) being information, first information and second information may both be same information and, in some cases, are separate and different information.

In addition, the terms “if ˜” and “in case that ˜” as used in the disclosure or claims may be interpreted to include the meanings of “when (or upon) ˜,” “in response to ˜,” “based on ˜,” or “according to ˜,” and may be used interchangeably with these expressions. In addition, expressions other than those exemplified herein may also be used, as long as they have substantially the same meaning and do not impair the technical features of the present disclosure.

For example, the physical layer signaling may be referred to as layer 1 (L1) signaling and may include downlink control information (DCI). In addition, the higher layer signaling may include a medium access control (MAC) control message, a radio resource control (RRC) signaling message, a non-access stratum (NAS) signaling message, or an application layer message. The RRC signaling message may be referred to as layer 3 (L3) signaling. It should be noted, however, that the higher layer signaling is not limited to the aforementioned examples.

In addition, the term “not perform” as used in the present disclosure or claims may, in context, be understood to mean that the corresponding step is omitted or skipped. Such a term may be replaced with other terms having the same or substantially equivalent meaning.

In addition, “transmitting a message including A and B” as described in the present disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the specific embodiments of the present disclosure described below, terms or components included in the disclosure may be expressed in singular or plural form depending on the specific embodiments presented. However, such singular or plural expressions are selected appropriately for convenience of description, and the present disclosure is not limited to a singular or plural number of components. A component expressed in the plural form may be implemented as a single component, and a component expressed in the singular form may be implemented as multiple components.

The drawings or flowcharts described below illustrate exemplary methods that may be implemented according to the principles of the present disclosure, and various modifications may be made to the methods illustrated in the flowcharts of the present disclosure. For example, although illustrated as a series of steps, various steps in each drawing or flowchart may overlap, occur in parallel, occur in a different order, or be repeated. In other examples, any step may be omitted or replaced with another step.

The methods and apparatuses provided in the embodiments of the present disclosure are not limited to each embodiment individually, but may also be applied in combination of all or some of the embodiments provided in the disclosure. Therefore, the embodiments of the present disclosure may be modified and applied without significantly departing from the scope of the present disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B,” such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the present disclosure is not limited to the terms described below, and other terms having equivalent technical meanings may also be used. Such terms may also be interchangeable with terms defined in any 3rd generation partnership project (3GPP) technical specifications (TS) where appropriate.

Hereinafter, a base station is an entity that allocates resources to terminals, and may be at least one of a gNode B, an eNode B, a Node B, a base station (BS), a wireless access unit, a BS controller, or a node on a network.

Furthermore, the base station of the present disclosure may include a split architecture comprising a central unit (CU) and a distributed unit (DU). In this structure, the CU is configured to process the higher layers of the control and user planes, while the DU is configured to process lower-layer radio resource functions. The embodiments of the present disclosure may be equally applicable to 5G base station architectures in which such CU and DU functional splits are implemented.

A terminal may include a UE, a mobile station (MS), a cellular phone, a smartphone, a computer, or a multimedia system capable of performing communication functions.

In the disclosure, a downlink (DL) refers to a radio link through which a BS transmits a signal to a UE, and an uplink (UL) refers to a radio link through which a UE transmits a signal to a BS.

Furthermore, hereinafter, 5th generation (5G) mobile communication technologies (e.g., 5G new radio (NR)), 6th generation (6G) mobile communication technologies may be described by way of example, but the embodiments of the present disclosure may also be applied to other communication systems having similar technical backgrounds or channel types. For example, newly evolved mobile communication systems developed after 5G and 6G may be included. Furthermore, based on determinations by those skilled in the art, the embodiments of the present disclosure may also be applied to other communication systems (e.g., Wi-Fi systems) through some modifications without significantly departing from the scope of the present disclosure.

In the following description, the terms physical channel and signal may be used interchangeably with data or control signal. For example, the term physical downlink shared channel (PDSCH) refers to a physical channel through which data is transmitted, but the term PDSCH may also be used to refer to the data itself. That is, in the present disclosure, the expression “transmit a physical channel” may be interpreted as being equivalent to the expression “transmit data or a signal via a physical channel.”

Hereinafter, in the context of the present disclosure, higher layer signaling may refer to signaling corresponding to at least one or any combination of the following: master information block (MIB), system information block (SIB) or SIB M (M=1, 2, . . . ), radio resource control (RRC), or medium access control (MAC) control element (CE), or a non-access stratum (NAS) signaling message, or an application layer message. The RRC signaling message may be referred to as L3 (layer 3) signaling.

In addition, L1 signaling may refer to signaling corresponding to at least one or any combination of signaling techniques using the at least one or any combination of the following physical layer channels or signaling: physical downlink control channel (PDCCH), downlink control information (DCI), user equipment (UE)-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

Hereinafter, the expression that information is configured by the BS, as used in the present disclosure or claims, may, in context, be understood to mean that the terminal receives the corresponding information from the BS via a physical layer signaling or a higher layer signaling. Such an expression may be replaced with other terms having the same or substantially equivalent meaning.

Hereinafter, the operational principle of the present disclosure will be described in detail with reference to the accompanying drawings.

The embodiments herein and the various features and advantageous details thereof are explained more fully with reference to the non-limiting embodiments that are illustrated in the accompanying drawings and details in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples can not be construed as limiting the scope of the embodiments herein.

As is in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the provided method. Likewise, the blocks of the embodiments be physically combined into more complex blocks without departing from the scope of the provided method.

The accompanying drawings aid in understanding the technical features, but the embodiments are not limited to these drawings. The provided method includes any alterations, equivalents, and substitutes beyond those shown. Terms like “first” and “second” are used for distinction and do not limit the elements.

Embodiments disclosed herein provide a system and method for cancelling requested location reporting triggers by an authorized MCX user. In an embodiment, the first location management client and the second location management client are used as examples, but this same concept can be applied to any number of location management clients. The present disclosure provides a method for an authorized MC service user, using a location management client, to cancel requested location reporting triggers for the location information of another MC service user at a location management client. The request can be used to cancel its own or another MC service user's requested location reporting triggers at another location management client. Further, the location management server can choose to cancel or update the location reporting configuration of the targeted MC service users at their location management clients.

Referring now to the drawings and more particularly to FIGS. 1 through 10, where similar reference characters denote corresponding features consistently throughout the figure, these are shown preferred embodiments.

FIG. 1 illustrates hardware features associated with the location management client of the first UE in a wireless communication network system according to the embodiments as disclosed herein. Examples of the first UE (105) and the second UE (106) can include, but are not limited to, consumer electronics (such as mobile phones and smartphones), tablets, wearable devices, computing devices (such as laptops, notebooks, desktops, workstations, etc.), IoT devices, automotive systems (such as connected cars, autonomous vehicles, vehicle-to-everything (V2X) communication devices, etc.), enterprise devices such as robotics, specialized equipment (such as medical devices, public safety devices, etc.), media devices (such as gaming consoles, streaming devices, etc.). Further, the first UE (105) and the second UE (106) can belong to the same user or different users.

Examples of the wireless communication network system include, but are not limited to, cellular networks (such as 2G, 3G, 4G, 5G, Beyond 5G (B5G)/6G or advanced cellular networks), local area networks (LANs) (such as Wi-Fi, Li-Fi, etc.), personal area networks (PANs) (such as Bluetooth, Zigbee, Z-Wave, etc.), wide area networks (WANs) (such as satellite communication networks, long range wide area network, narrowband IoT, low-bandwidth communication for IoT, etc.), metropolitan area networks (MANs), machine-to-machine (M2M), Ad Hoc and mesh networks, emerging and advanced Networks.

With reference to FIG. 1, the first location management client (100) can encompass a diverse range of devices including, but not limited to, SEAL LM client, edge enabler client, application data analytics enablement (ADAE) client, among others. The first location management client (100) is a functional entity that acts as an application client for location management functions. The first location management client (100) interacts with the location management server (200) and provides the UE-based positioning and location-related information. The first location management client (100) also supports interactions with the corresponding location management client between the two UEs.

In an embodiment, the first location management client (100) includes a memory (101), a processor (102), an I/O interface/controller (104), and a location reporting trigger controller (103). The memory (101) stores instructions for the processor (102) and can include non-volatile storage elements such as magnetic hard disks, optical disks, floppy disks, flash memories, EPROM, or EEPROM. The memory (101) may be considered a non-transitory storage medium, indicating it is not a carrier wave or propagated signal, though it can be movable. It can store large amounts of information and data that may change over time, such as in RAM or cache. The memory (101) holds the location information of the second location management client (300), a functional alias, the user identity of the first location management client (100), security parameters, and the identities and location reports of both the first (100) and second (300) location management clients.

The processor (102) may include one or a plurality of processors. The one or the plurality of processors may be a general-purpose processor such as a central processing unit (CPU), an application processor (AP) or the like, a graphics-only processing unit such as a graphics processing unit (GPU), a visual processing unit (VPU), and/or an AI-dedicated processor such as a neural processing unit (NPU). The processor (102) may include multiple cores and is configured to execute the instructions stored in the memory (101). The processor (102) fetches location information of the second location management client (300) or a functional alias, a user identity of the first location management client (100), security parameters, an identity of the first location management client (100), an identity of the second location management client (300), a location report of the second location management client (300), and others. Further, the processor (102) retrieves instructions and executes them.

The I/O interface/controller (104) transmits the information between the memory (101) and external peripheral devices. The peripheral devices are the input-output devices associated with the location management client (100) of the first UE (105). The I/O interface (104) receives several pieces of information from a plurality of UEs, network devices, servers, and the like. The I/O interface (104) ensures that the operating speed of the processor is synchronized with respect to the input and output devices. The I/O interface (104) establishes a connection between different peripheral devices like location reporting trigger controller (103), memory (101), and others to perform the location service support for any scenario-specific action like to enable or disable the location report trigger of the second location management client (300).

In an embodiment, the location reporting trigger controller (103) of the first location management client (100) communicates with the processor (102), the I/O interface (104), and the memory (101) to manage location reporting in the wireless network system. The location reporting trigger controller (103) transmits the location reporting trigger to the location management server (200) to obtain location information of the MC service user at the second location management client (300). The first location management client (100) resides on the first MC service UE, and the second location management client resides on a second MC service UE. A location report, which is a message used in mobility management and positioning procedures, provides the location of the user.

Further, the first location management client (100) determines that the location information of the MC service user at the second location management client is deemed unnecessary and transmits a location reporting trigger update or location reporting trigger cancel request to the location management server (200). This determination can be based on predefined criteria such as the users activity status, proximity to known locations, or changes in network conditions. The location reporting trigger update may include modifications to the frequency of location updates or adjustments to the accuracy requirements based on the current operational needs. The location reporting trigger cancel request is processed to halt any ongoing location tracking activities, thereby conserving network resources and reducing unnecessary data transmission. The location management server (200) acknowledges the update or cancel request and adjusts its operations accordingly to reflect the new location reporting parameters.

In an embodiment, the second client device comprises at least one of a second client device authorized MC service user or one or more functional aliases. The functional aliases comprise one or more client devices that have activated the functional aliases, which can be used to represent different roles or identities within the MC service network. These aliases allow for flexible and dynamic management of user identities and permissions, facilitating seamless communication and coordination among various users. The location reporting trigger update or cancel request comprises an MC service ID, functional aliases information, and an MC service ID list. The MC service ID uniquely identifies each user within the network, while the functional aliases information provides context on the roles or identities associated with the user. The MC service ID list includes all relevant identifiers that may be updated or cancelled, ensuring management of location reporting triggers across the network.

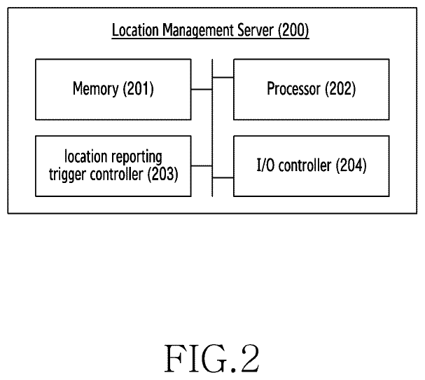

FIG. 2 illustrates hardware features associated with the location management server (200) according to the embodiments as disclosed herein. With reference to FIG. 2, the location management server (200) can encompass a diverse range of devices, including but not limited to location management function (LMF), access and mobility management function (AMF), edge enabler server, ADAE server, and others. The location management server (200) is a functional entity that receives and stores user location information and provides user location information to the requested and authorized location management client.

The location management server (200) also supports reporting the value-added location information (e.g., geofencing, monitoring events, history location data, prediction related to UE location, and others) to the first location management client. In an embodiment, the location management server (200) includes a memory (201), a processor (202), an I/O interface/controller (204), and a location reporting trigger controller (203).

The memory (201) stores instructions for the processor (202) and includes non-volatile storage elements such as magnetic hard disks, optical disks, floppy disks, flash memories, EPROM, and EEPROM. The memory (201) may be considered a non-transitory storage medium, indicating it is not a carrier wave or propagated signal, but it can be movable. It can store large amounts of information, including data that changes over time (e.g., RAM or cache). The memory (201) also stores location information of the second location management client (300), a functional alias, user identity of the first location management client (100), security parameters, identities of both location management clients, and location reports of the second location management client (300).

The processor (202) may include one or a plurality of processors. The one or the plurality of processors may be a general-purpose processor such as a central processing unit (CPU), an application processor (AP), or the like, a graphics-only processing unit such as a graphics processing unit (GPU), a visual processing Unit (VPU), and/or an AI-dedicated processor such as a neural processing unit (NPU). The processor (202) may include multiple cores and is configured to execute the instructions stored in the memory (201). The processor (202) fetches and stores the location information of the second location management client (300) or a functional alias, a user identity of the first location management client (100), security parameters, an identity of the first location management client (100), an identity of the second location management client (300), a location report of the second location management client (300), and others. Further, the processor (202) retrieves instructions and executes them.

The I/O interface (204) transmits information between the memory (201) and external peripheral devices, which are the input-output devices associated with the first location management client (100). It receives information from various UEs, network devices, servers, etc., and ensures the processor's operating speed is synchronized with the input and output devices. The I/O interface (204) connects different peripheral devices, such as the location reporting trigger controller (203) and memory (201), to support location services for specific scenarios.

The location reporting trigger controller (203) receives the location reporting trigger update or location reporting trigger cancel request from the first location management client (100) to update or cancel the location reporting trigger. The first location management client (100) resides on a first MC service UE. Further, the location reporting trigger controller (203) verifies whether the first location management client is authorized to update or cancel the location reporting trigger request for the second client device and determines that the first location management client is authorized to update or cancel the location reporting trigger. The verification process involves checking the credentials and permissions associated with the first location management client against a predefined authorization database. Upon receiving the location reporting trigger update or location reporting trigger cancel request from the first location management client device (100), the location reporting trigger controller (203) initiates an event-triggered location reporting trigger update or cancel for the second location management client. This initiation process includes generating a unique transaction ID for tracking the request and logging the event in the system's audit trail for future reference.

In an embodiment, the location reporting trigger controller updates the location reporting configuration of the second location management client (300) when the second location management client is configured to report its location information based on the location reporting trigger received from other second location management clients in addition to the first location management client. The update process involves modifying the location reporting parameters such as the frequency of location updates, location data, the precision of the location data etc. The controller ensures that the updated configuration is compatible with the network infrastructure and does not interfere with other ongoing location reporting activities. Further, the controller may perform a validation check to confirm that the new configuration meets the necessary performance and security standards.

In an embodiment, the location reporting trigger controller (203) updates the location reporting configuration to ensure continued reporting of location information if the second location management client receives the location reporting trigger from other location management clients. This involves dynamically adjusting the reporting intervals and thresholds based on the number of active triggers and the priority assigned to each trigger. The controller may also implement load balancing techniques to distribute the reporting load evenly across multiple clients to prevent network congestion. Furthermore, the controller can employ machine learning algorithms to predict and preemptively adjust the reporting configuration based on historical data and usage patterns.

In an embodiment, the location reporting trigger controller (203) sends a notification to the first location management client of the status of the location reporting trigger cancel request after verification by the location management server (200). The notification includes detailed information about the outcome of the request, such as whether the cancelation was successful, any errors encountered during the process, and the current status of the location reporting trigger. The notification is transmitted using a secure communication channel to ensure the integrity and confidentiality of the information. Further, the controller logs the notification event and any associated metadata in the system's database for audit and compliance purposes.

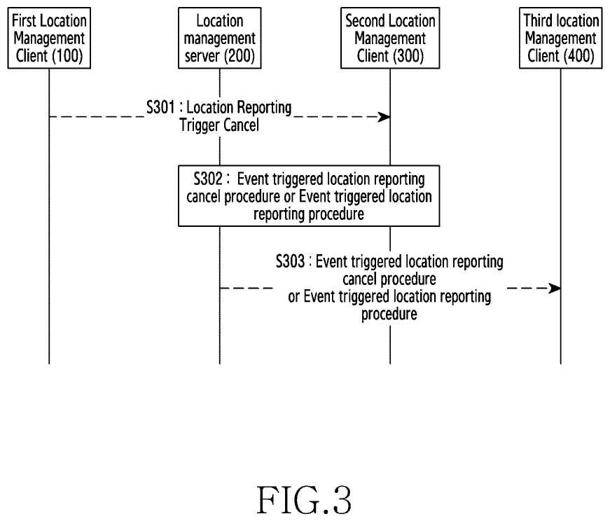

FIG. 3 illustrates a sequence diagram of client-triggered location reporting cancel procedure according to embodiments as disclosed herein.

Table 1 describes the information flow from location management client to the location management server to stop triggering a location reporting procedure.

TABLE 1
Location reporting trigger cancel

| Information | | |
|---|---|---|
| element | Status | Description |
| MC service ID | M | Identity of the requesting authorized MC service user |
| | (see NOTE 1) | (e.g., MCPTT ID, MCVideo ID, MCData ID) |
| Functional alias | O | Functional alias that corresponds to the requesting MC |
| | | service user (e.g., MCPTT ID, MCVideo ID, MCData ID) |
| MC service ID list | O | List of MC service users whose location information |
| | (see NOTE 1) | reporting is to be cancelled (e.g., MCPTT ID, |
| | (see NOTE 2) | MCVideo ID, MCData ID) |
| Functional alias | O | Functional alias that corresponds to the MC service |
| | (see NOTE 2) | users whose location information reporting is to be |
| | | cancelled (e.g., MCPTT ID, MCVideo ID, MCData ID). |
| ClearAll | O | Indicates whether others MC service users provided |
| | (see NOTE 2) | location reporting triggers are cancelled along with |
| | | own location reporting triggers. |
| ClearOthers | O | Indicates whether only others MC service users |
| | (see NOTE 2) | provided location reporting triggers are cancelled. |

(NOTE 1):
The identity of the requesting MC service user and the requested MC service user may belong to the same MC service. E.g., if requesting MC service user is using a MCPTT ID, then the requested MC service user identity may be an MCPTT ID.
(NOTE 2):
Either the MC service ID list or the Functional alias may be present.
(NOTE 3):
If included, either one of ClearAll or ClearOthers is present. If not present, then clear own provided location reporting triggers.

Pre-conditions: The first location management client (100) has provided the location reporting trigger for the second location management client (300) and third location management client (400).

At step S301, first location management client (100) (authorized MC service user) sends a location reporting trigger cancel request to the location management server to deactivate a location reporting procedure for obtaining the location information of the second location management client (300) and the third location management client (400).

At step S302, the location management server checks whether the first location management client (100) is authorized to send a location reporting trigger cancel request for location management client 2's and location management client 3's location information. Depending on the location reporting configuration information, location management server may initiates a location reporting cancel procedure for the second location management client (300) and third location management client (400) as specified in 3GPP TS 23.280 or event-triggered location reporting procedure to update the configuration of the second location management client (300) and third location management client (400) as specified in 3GPP TS 23.280.

The above procedure is valid for single MC system operation only. The location management client (authorized MC service user) can cancel other location management clients (authorized MC service user) provided location reporting trigger for reporting location information along with its own provided location reporting triggers.

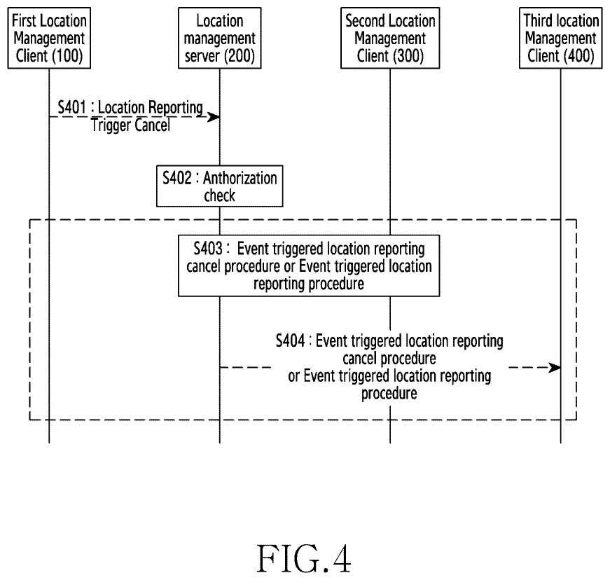

FIG. 4 illustrates a sequence diagram of a method for a periodic location information report cancellation for shared functional aliases according to embodiments disclosed herein. The diagram demonstrates the method where the location management client requests to cancel the periodic location information from other location management clients for location information reporting using functional aliases, which may be shared between several MC service users.

In pre-conditions, MC service users at the second location management client (300) and third location management client (400) share the same functional alias. The MC service users at the second location management client (300) and third location management client (400) have activated the functional alias. Further the MC service user at the first location management client (100) may have an activated functional alias. The location management server has subscribed to the functional alias controlling MC service server within the MC system for functional alias activation/deactivation updates.

At step S401, the first location management client (100) (authorized MC service user) sends a location reporting trigger cancel request, limited to one MC service at a time, to the location management server to deactivate a periodic location reporting procedure. This procedure retrieves the location information of the MC service users sharing the contained functional alias. The first location management client (100) may include its own activated functional alias.

At step S402, the location management server (200) checks whether the first location management client (100) is authorized to send a location reporting trigger cancel request for the location information of the location management clients that have activated the functional alias. The location management server determines the functional alias corresponding to a list of related MC service IDs of the second location management client (300) and third location management client (400) who have activated the functional alias.

At steps S403 and S404, depending on the location reporting configuration information, the location management server may initiate a location reporting cancel procedure for the second location management client (300) and third location management client (400) as specified in 3GPP TS 23280. Further, an event-triggered location reporting procedure may be initiated to update the configuration of the second location management client (300) and third location management client (400) as specified in 3GPP TS 23280.

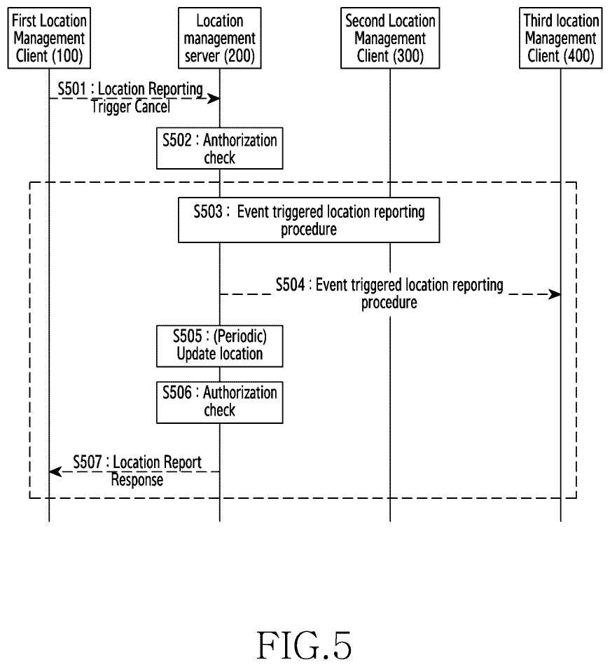

FIG. 5 illustrates a method where the first location management client requests periodic location information from other location management clients for location information reporting using functional aliases, which may be shared among several MC service users. Under this condition, the actual location of all MC service users sharing the same functional alias is reported.

In one embodiment, the method is updated to clarify that when a functional alias is deactivated for an MC service client, the location management server (200) deactivates location information reporting for the location management client using an event-triggered location reporting cancel procedure. Conversely, when a functional alias is newly activated for an MC service client, the location management server activates location information reporting for this location management client using an event-triggered location reporting procedure.

Pre-conditions are MC service client 2 and MC service client 3 share the same functional alias, MC service client 2 and MC service client 3 have activated the functional alias, MC service client 1 may have an activated functional alias, the location management server has subscribed to the functional alias controlling MC service server within the MC system for functional alias activation/deactivation updates.

At step S501, the first location management client (100) sends a location reporting trigger, limited to one MC service at a time, to the location management server to activate a periodic location reporting procedure. This procedure retrieves the location information of the MC service users sharing the contained functional alias. The first location management client (100) may include its own activated functional alias.

At step S502, the location management server checks whether the first location management client (100) is authorized to send a location reporting trigger for location information for location management clients that have activated the functional alias.

At step S503, depending on the information provided by the location reporting trigger, the location management server (200) uses an event-triggered location information procedure and immediately sends a location information request to the location management clients that contain the functional alias requested by the first location management client (100).

At step S504, upon receiving the reports, the location management server updates the location of the reporting location management clients.

At step S505, the location management server checks whether the first location management client (100) is authorized to receive location information for all location management clients that have activated the functional alias.

At step S506, based on the received location information reports, the location management server periodically issues location report responses, one at a time, for each location management client for which the first location management client (100) is authorized to receive location information. These responses encompass the MC service ID, the associated functional alias, the individual location information of the addressed MC service ID, and the optional MC service UE label, if present.

NOTE 1: When a functional alias is deactivated for an MC service client, the location management server deactivates location information reporting for this location management client using event-triggered location reporting cancel procedure as specified in 3GPP TS 23.280.

NOTE 2: When a functional alias has been newly activated for an MC service client, the location management server activates location information reporting for this location management client using event-triggered location reporting procedure as specified in 3GPP TS 23.280.

NOTE 3: When a functional alias is simultaneously shared between several MC service IDs, all location management clients with the associated MC service IDs may send the location report until the functional alias status change, e.g., take-over, for the individual MC service ID.

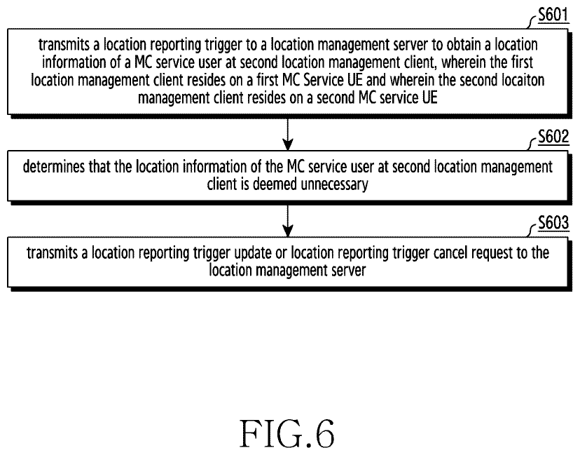

FIG. 6 illustrates the scenario of the method for canceling requested location reporting triggers for the location information of another MC service user. The method includes transmitting by the first location management client (100) the location reporting trigger to the location management server (200) to obtain location information of the MC service user at the second location management client. The first location management client (100) resides on a first MC service UE and the second location management client (300) resides on a second MC service UE. The location reporting trigger may include parameters such as the frequency of location updates, the specific geographic area of interest, and the duration for which the location reporting is performed. The first MC service UE may be equipped with GPS, Wi-Fi, and cellular triangulation capabilities to accurately determine its location. The communication between the first location management client and the location management server is facilitated through secure protocols to ensure the integrity and confidentiality of the location data.

At step S602, the first location management client (100) determines that the location information of the MC service user at the second location management client (300) is deemed unnecessary. Upon finding that the location information of the MC service user is unnecessary, the first location management client (100) transmits the location reporting trigger update or location reporting trigger cancel request to the location management server (200) as illustrated at step S603. The determination of unnecessary location information may be based on predefined criteria such as the completion of a specific task, the user moving out of a designated area, or the expiration of a time period. The location reporting trigger update or cancel request may include metadata such as the reason for cancellation, timestamp, and the identity of the requesting client. The communication protocol used for transmitting the request ensures low latency and high reliability to promptly update the location reporting status.

In an embodiment, the second client device comprises at least one of a second client device authorized MC service user or one or more functional aliases, wherein the functional aliases comprise one or more client devices that have activated the functional aliases. In another embodiment, the location reporting trigger update or cancel request comprises an MC service ID, functional aliases information, and an MC service ID list. The functional aliases allow multiple devices to share a common identity for location reporting purposes, enhancing the flexibility and scalability of the system. The MC service ID list may include identifiers for various MC service users or groups, enabling targeted location reporting management. The system architecture supports dynamic updates to the functional aliases and MC service ID list to accommodate changes in user roles and responsibilities.

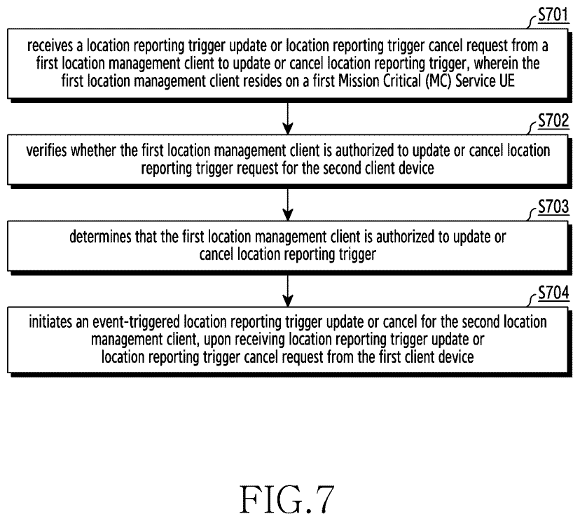

Referring to FIG. 7, which illustrates the scenario of managing location reporting by the location management server (200). At step S701, the location management server (200) receives a location reporting trigger update or a location reporting trigger cancel request from the first location management client (100) to update or cancel the location reporting trigger. The first location management client (100) resides on a first MC service UE. The location management server processes the request using advanced algorithms to ensure accurate and timely updates to the location reporting configuration. The server may also log the request details for auditing and troubleshooting purposes. The communication between the location management server and the first location management client is encrypted to prevent unauthorized access to sensitive location data.

At step S702, the location management server (200) verifies whether the first location management client (100) is authorized to update or cancel the location reporting trigger request for the second location management client's location information. The second location management client (300) resides on a second MC service UE. The authorization process involves checking the credentials and permissions of the first location management client against a centralized database. The server may employ multi-factor authentication mechanisms to enhance security. If the first location management client is not authorized, the server generates an alert and logs the unauthorized attempt for further investigation.

Further, the location management server (200) determines that the first location management client (100) is authorized to update or cancel the location reporting trigger as illustrated at step S703. Upon receiving the location reporting trigger update or location reporting trigger cancel request from the first location management client (100), the location management server (200) initiates the event-triggered location reporting trigger update or cancel for the location information of the second location management client (300). The server may use machine learning algorithms to predict the impact of the update or cancellation on the overall location reporting system. The event-triggered mechanism ensures that the changes are applied immediately, minimizing any delay in the location reporting process.

In an embodiment, the location management server (200) updates the location reporting configuration of the second location management client (300) when the second location management client is configured to report its location information based on a location reporting trigger received from other location management clients in addition to the first location management client (100). The server may aggregate location reporting triggers from multiple clients to optimize the reporting intervals and reduce redundant data transmission. The updated configuration may include new reporting schedules, geographic boundaries, and priority levels for different location reporting triggers.

In an embodiment, the location management server (200) updates the location reporting configuration to ensure continued reporting of location information of the second location management client if it has received the location reporting trigger from other location management clients. The server maintains a record of all active location reporting triggers to ensure seamless continuity in location reporting. The configuration update process may involve recalibrating the reporting parameters to align with the latest triggers received from other clients. The server may also notify the second location management client of any changes to its reporting configuration.

In an embodiment, the location management server (200) sends a notification to the first location management client regarding the status of the location reporting trigger cancel request after verification by the location management server. The notification may include details such as the outcome of the verification process, the effective time of the cancellation, and any additional actions performed by the first location management client.

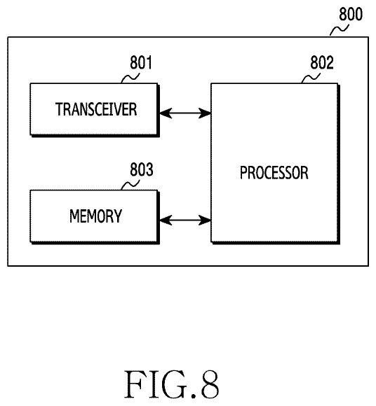

FIG. 8 illustrates a terminal or user equipment (UE) 800 according to an embodiment of the disclosure.

The terminal is an electronic device capable of wireless communication, may include a User Equipment (UE), a portable phone, a smartphone, a tablet, an Internet of things (IoT) device, etc., having various form factors, and may perform wireless communication with a base station (BS) through a wireless channel.

Referring to FIG. 8, the UE 800 may include at least one transceiver (hereinafter, referred to as simply “transceiver”) 801, at least one processor (hereinafter, referred to as simply “processor”) 802, and at least one memory (hereinafter, referred to as simply “memory”) 803. According to at least one or a combination of methods corresponding to the embodiments described in the present disclosure, the transceiver 801, the processor 802, and the memory 803 of the UE 800 may operate. However, components of the UE 800 are not limited to the exemplary components illustrated in FIG. 8. In another embodiment, the UE 800 may further include additional components in addition to the above-mentioned components, or some components may be omitted. Further, in some embodiments, any combination of the transceiver 801, the processor 802, or the memory 803 may be integrated in the form of one component.

The transceiver 801 may be a communication circuit or communication circuitry that enables the UE 800 to perform wireless communication with a node or an entity of a network. For example, the transceiver 801 may enable the UE 800 to transmit or receive a signal to or from a BS through cellular communication, or to transmit or receive a signal to or from another UE through cellular communication. For example, the transceiver 801 may support at least one of various cellular communication technologies including 3rd generation (3G), 4th generation (4G), long term evolution (LTE), 5th generation (5G) NR, 6th generation (6G), and various cellular wireless communication technologies supported by the transceiver (801) may include all subsequent generations of evolved wireless communications.

According to an embodiment, the UE 800 may include a plurality of transceivers. For example, in the case of supporting evolved-universal terrestrial radio access-new radio (E-UTRA-NR) dual connectivity (EN-DC), the UE 800 may include a first transceiver supporting the 4G LTE wireless communication and a second transceiver supporting the 5G NR wireless communication. According to another embodiment, in the case of supporting NR-dual connectivity (NR-DC), the UE 800 may include a plurality of transceivers supporting the 5G NR wireless communication. According to still another embodiment, in the case of supporting near field wireless communication, the UE 800 may separately include a transceiver supporting at least one standard in the group of wireless communication protocol standards as defined in the protocol standards for Bluetooth®, wireless local area network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

According to an embodiment, the transceiver 801 may include various circuit structures used to transmit or receive signals to or from a BS through a wireless channel. The signals may include control information and data. For example, the transceiver 801 may include a radio frequency (RF) transmitter for up-converting and amplifying the frequency of a transmitted signal and an RF receiver for low-noise-amplifying a received signal and down-converting the frequency thereof. The transceiver 801 may output a signal received through a wireless channel to the processor 802 and may transmit, through a wireless channel, a signal output from the processor 802.

The processor 802 may control general operations of the UE 800 according to embodiments of the disclosure. The processor 802 may be implemented by one or more integrated circuit (or circuitry) (IC) chips and may execute various data processing. The processor 802 may include at least one electric circuit, and may execute instructions (or a program, codes, data, etc.) stored in the memory 803, individually, collectively or in any combination thereof. Further, the processor 802 may include a single-core processor or multi-core processor, and may include a processor assembly including a plurality of processing circuits (circuitry) according to a specific implementation scheme.

The processor 802 may be electrically, operatively, or communicatively coupled to the transceiver 801 to control the transceiver 801.

The processor 802 may include at least one processor (or processing circuitry), and the at least one processor may perform the following operations individually, collectively or in any combination thereof. For example, the processor 802 may include a communication processor (CP) configured to control communication operations and an application processor (AP) configured to control execution of an upper layer (for example, an application layer). In a specific embodiment, at least a part of the processor 802 may be included in one chip and the other part of the processor 802 may be included in another chip. Otherwise, at least one processor may be included in another component, for example, the transceiver 801 or the memory 803.

The processor 802 may perform or control or cause an operation of the UE 800 for executing at least one or a combination of methods according to embodiments of the disclosure. For example, the processor 802 may control operations of the UE 800 for processing a downlink signal received from a BS or generating and transmitting an uplink signal to a BS. To this end, the processor 802 may execute a computer program, codes, or instructions stored in the memory 803, so as to control other components of the UE 800 to enable execution of various operations.

The memory 803 corresponds to a hardware storage device capable of temporarily or permanently storing information and may include one or more storage media. For example, the memory 803 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 803 may be electrically, operatively, or communicatively coupled to the processor 802 and may be accessed by the processor 802.

The memory 803 may store a computer program, codes, or instructions executable by the processor 802. According to an embodiment, a computer program, codes, or instructions executable by the processor 802 may be either stored in a single memory device or separated and distributedly stored in two or more memory devices. By executing the instructions stored in the memory 803, the processor 802 may perform various functions according to an embodiment of the disclosure.

According to an embodiment of the disclosure, operations of the UE 800 may be caused to be performed based on execution of instructions (or a computer program or codes) stored in the memory 803 by at least one processor (or processing circuitry) configured to execute the same individually, collectively, or in any combination thereof, based on processing circuitry that is not configured to execute instructions, and/or based on components of processing circuitry that is not configured to execute instructions.

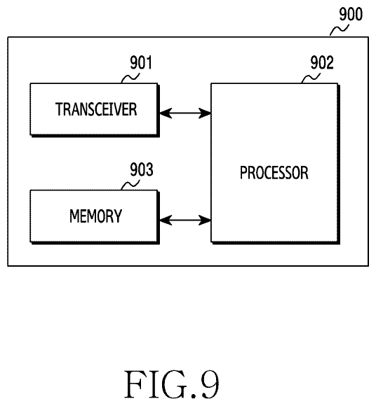

FIG. 9 illustrates a base station (BS) 900 according to an embodiment of the disclosure.

The BS 900 may perform wireless communication with at least one user equipment (UE) located within the area of the BS 900 through a wireless channel.

Referring to FIG. 9, the BS 900 may include at least one transceiver (hereinafter, referred to as simply “transceiver”) 901, at least one processor (hereinafter, referred to as simply “processor”) 902, and at least one memory (hereinafter, referred to as simply “memory”) 903. According to at least one or a combination of methods corresponding to the embodiments described in the present disclosure, the transceiver 901, the processor 902, and the memory 903 of the BS 900 may operate. However, components of the BS 900 are not limited to the exemplary components illustrated in FIG. 9. In another embodiment, the BS 900 may further include additional components in addition to the above-mentioned components, or some components may be omitted. Further, in some embodiments, any combination of the transceiver 901, the processor 902, or the memory 903 may be integrated in the form of one component.

The transceiver 901 may be a communication circuit or communication circuitry that enables the BS 900 to perform wireless communication with a node or an entity of a network. For example, the transceiver 901 may enable the BS 900 to transmit or receive a signal to or from the UE 800 through cellular communication, or to transmit or receive a signal to or from another network entity through wireless communication. For example, the transceiver 901 may support various cellular communication technologies including 3rd generation (3G), 4th generation (4G), long term evolution (LTE), 5th generation (5G) NR, 6th generation (6G), and various cellular wireless communication technologies supported by the transceiver (901) may include all subsequent generations of evolved wireless communications. According to an embodiment, the transceiver 901 may include various circuit structures used to transmit or receive signals to or from a UE through a wireless channel. The signals may include control information and data. For example, the transceiver 901 may include a radio frequency (RF) transmitter for up-converting and amplifying the frequency of a transmitted signal and an RF receiver for low-noise-amplifying a received signal and down-converting the frequency thereof. The transceiver 901 may output a signal received through a wireless channel to the processor 902 and may transmit, through a wireless channel, a signal output from the processor 902.

Meanwhile, according to an embodiment of the present disclosure, the BS 900 may perform communication with a node or an entity of a network through wired or wireless communication. For example, the BS 900 may perform wired or wireless communication with an adjacent BS, or a node or an entity of a core network through a backhaul network. Although not illustrated in FIG. 9, when the BS 900 performs wired communication, the BS 900 may further include a separate network interface for wired communication in addition to the transceiver 901. The network interface may be referred to as network interface circuitry or communication interface circuitry.

The processor 902 may control general operations of the BS 900 according to embodiments of the disclosure. The processor 902 may be implemented by one or more integrated circuit (or circuitry) (IC) chips and may execute various data processing. The processor 902 may include at least one electric circuit, and may execute instructions (or a program, codes, data, etc.) stored in the memory 903, individually, collectively or in any combination thereof. Further, the processor 902 may include a single-core processor or multi-core processor, and may include a processor assembly including a plurality of processing circuits (circuitry) according to a specific implementation scheme.

The processor 902 may be electrically, operatively, or communicatively coupled to the transceiver 901 to control the transceiver 901.

The processor 902 may include at least one processor (or processing circuitry), and the at least one processor may perform the following operations individually, collectively or in any combination thereof. In a specific embodiment, at least a part of the processor 902 may be included in one chip and the other part of the processor 902 may be included in another chip. Otherwise, at least one processor may be included in another component, for example, the transceiver 901 or the memory 903.

The processor 902 may perform or control or cause an operation of the BS 900 for executing at least one or a combination of methods according to embodiments of the disclosure. For example, the processor 902 may control operations of the BS 900 for generating and transmitting a downlink signal to a UE or processing an uplink signal received from a UE. Otherwise, the BS 900 may transmit or receive a signal to or from a neighboring BS, transfer a signal received from a UE to an upper node of the network, or transmit a signal transferred from an upper node of the network to a UE. To this end, the processor 902 may execute a computer program, codes, or instructions stored in the memory 903, so as to control other components of the BS 900 to enable execution of various operations.

The memory 903 corresponds to a hardware storage device capable of temporarily or permanently storing information and may include one or more storage media. For example, the memory 903 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 903 may be electrically, operatively, or communicatively coupled to the processor 902 and may be accessed by the processor 902.

The memory 903 may store a computer program, codes, or instructions executable by the processor 902. According to an embodiment, a computer program, codes, or instructions executable by the processor 902 may be either stored in a single memory device or separated and distributedly stored in two or more memory devices. By executing the instructions stored in the memory 903, the processor 902 may perform various functions according to an embodiment of the disclosure.

According to an embodiment of the disclosure, operations of the BS 900 may be caused to be performed based on execution of instructions (or a computer program or codes) stored in the memory 903 by at least one processor (or processing circuitry) configured to execute the same individually, collectively, or in any combination thereof, based on processing circuitry that is not configured to execute instructions, and/or based on components of processing circuitry that is not configured to execute instructions.

The UE or the base station may perform various communication procedures related to the control plane or the user plane by cooperating with one or more network entities based on wireless communication. For example, the UE may communicate with network entity such as an access and mobility management function (AMF) or a session management function (SMF) via the base station, or the base station may perform at least one communication procedure by directly transmitting and receiving signals to/from, or relaying signals between, the network entities.

The structure of the above-described network entity will be described in more detail with reference to the drawings.

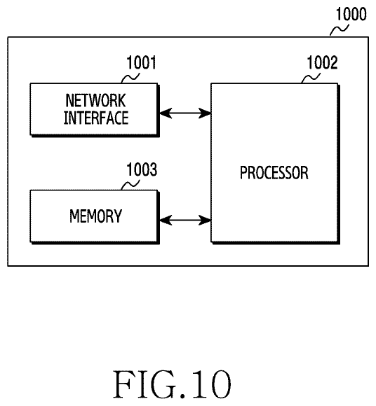

FIG. 10 illustrates a network entity 1000 according to an embodiment of the disclosure.

The network entity 1000 may include an entity (apparatus, device, or server, etc.) that performs one or more network functions (NFs) or a part of a network function constituting a core network (e.g., a 5th generation (5G) core (5GC)) in a communication system. In this case, multiple NFs may be implemented within a single network entity, or a single NF may be distributed and implemented across a plurality of network entities. In addition, when an NF is implemented within the network entity, the NF may be implemented in the form of software, and in such a case, a program for operating the NF may be stored in memory of the network entity 1000.

A single NF may be implemented by one or more instances, which may be deployed on the same network entity or distributed across multiple network entities to operate. The instance may be a software unit that logically executes a specific network function, and may be implemented in a form that is decoupled from physical hardware resources. Further, one or more NFs may be implemented in the form of one network slice to operate to satisfy specifications achieved by a particular service.

The NF may include at least one of an access and mobility management function (AMF), a session management function (SMF), a local session management function (L-SMF), a user plane function (UPF), a local user plane function (L-UPF), a policy control function (PCF), a unified data management (UDM), a unified data repository (UDR), a network exposure function (NEF), a network repository function (NRF), an application function (AF), a network slice selection function (NSSF), a network data analytics function (NWDAF), a network slice admission control function (NSACF), an authentication server function (AUSF), or a data network (DN).

Referring to FIG. 10, the network entity 1000 may include at least one network interface 1001, at least one processor 1002 (hereinafter, “processor”), and at least one memory 1003 (hereinafter, “memory”). As described above, a NF may be implemented in the form of a physical device such as the network entity 1000, or may be virtualized and executed in the form of an instance. When implemented as an instance, the NF may not necessarily include physical components as illustrated in FIG. 10. In such a case, the instance may be logically represented as comprising one or more logical functional elements.

According to at least one or a combination of methods corresponding to the embodiments described in the present disclosure, the network interface 1001, the processor 1002, and the memory 1003 of the network entity 1000 may operate. However, components of the network entity 1000 are not limited to the exemplary components illustrated in FIG. 10. In another embodiment, the network entity 1000 may further include additional components in addition to the above-mentioned components, or some components may be omitted. Further, in an embodiment, the network interface 1001, the processor 1002, or the memory 1003 may be integrated in the form of one component.

The network interface 1001 is a collective term for a transmitter part of the network entity 1000 and a receiver part of the network entity 1000, and may be a communication circuit for transmitting or receiving a signal to or from a user equipment (UE), a base station (BS), or another network entity. Here, the communication circuit may include both a communication circuit for wireless communication and a communication circuit for a wired communication. For example, the network interface 1001 may include a circuit, logic, hardware, etc., configured to exchange a control plane message or a user plane message with a UE, a BS, or other core network entities through wireless communication or wired communication. The network interface 1001 may operate using various protocols (e.g., non-access stratum (NAS) protocol). The network interface 1001 may also be referred to, for convenience of description or depending on implementation, as communication circuitry, network interface circuitry, or a communication interface circuitry.

The processor 1002 may control general operations of the network entity 1000 according to embodiments of the disclosure. The processor 1002 may be implemented by one or more integrated circuit (or circuitry) (IC) chips and may execute various data processing. The processor 1002 may include at least one electric circuit, and may execute instructions (or a program, codes, data, etc.) stored in the memory 1003, individually, collectively or in any combination thereof. Further, the processor 1002 may include a single-core processor or multi-core processor, and may include a processor assembly including a plurality of processing circuits (circuitry) according to a specific implementation scheme. Further, it should be noted that, according to another embodiment, in a case where NF is implemented in the form of an instance, the network function may be not necessarily configured by physical hardware.

According to an embodiment, the processor 1002 may be electrically, operatively, or communicatively coupled to the network interface 1001 to control the network interface 1001.

The processor 1002 may include at least one processor (or processing circuitry), and the at least one processor may perform the following operations individually, collectively or in any combination thereof. In a specific embodiment, at least a part of the processor 1002 may be included in one chip and the other part of the processor 1002 may be included in another chip. Otherwise, at least one processor may be included in another component, for example, the network interface 1001 or the memory 1003.

The processor 1002 may perform or control or cause an operation of the network entity 1000 for executing at least one or a combination of methods according to embodiments of the disclosure. For example, the processor 1002 may control operations of the network entity 1000 for exchanging a control plane message or a user plane message with a UE, a BS, or other core network entities through wireless or wired communication, using various protocols (e.g., NAS protocol). To this end, the processor 1002 may execute a computer program, codes, or instructions stored in the memory 1003, so as to control other components of the network entity 1000 to enable execution of various operations.

The memory 1003 corresponds to a hardware storage device capable of temporarily or permanently storing information and may include one or more storage media. For example, the memory 1003 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1003 may be electrically, operatively, or communicatively coupled to the processor 1002 and may be accessed by the processor 1002.

The memory 1003 may store a computer program, codes, or instructions executable by the processor 1002. According to an embodiment, a computer program, codes, or instructions executable by the processor 1002 may be either stored in a single memory device or separated and distributedly stored in two or more memory devices. By executing the instructions stored in the memory 1003, the processor 1002 may perform various functions according to an embodiment of the disclosure.

According to an embodiment of the disclosure, operations of the network entity 1000 may be caused to be performed based on execution of instructions (or a computer program or codes) stored in the memory 1003 by at least one processor (or processing circuitry) configured to execute the same individually, collectively, or in any combination thereof, based on processing circuitry that is not configured to execute instructions, and/or based on components of processing circuitry that is not configured to execute instructions.

Meanwhile, although specific embodiments of the present disclosure have been described in detail, various modifications may be made without departing from the scope of the present disclosure. Therefore, the scope of the present disclosure should not be limited to the described embodiments, but should be defined by the claims and equivalents thereof.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a location management server, the method comprising:
receiving, from a first location management client providing a first location reporting trigger for a second location management client, a location reporting trigger cancel request to deactivate a first location reporting procedure for obtaining location information of the second location management client; and
identifying that the first location management client is authorized to transmit the location reporting trigger cancel request,
wherein the location reporting trigger cancel request deactivates a second location reporting procedure triggered by a third location management client providing a second location reporting trigger for the second location management client, and
wherein the first location management client and the third location management client are for an authorized mission critical (MC) service user.

2. The method of claim 1, further comprising:
performing an event-triggered location reporting cancel procedure for the second location management client; or
updating a location reporting configuration of the second location management client.

3. The method of claim 1, wherein the first location reporting procedure is for obtaining location information of a fourth location management client, and
wherein the second location management client and the fourth location management client share a functional alias.

4. The method of claim 3, wherein the location reporting trigger cancel request is limited to one MC service at a time.

5. The method of claim 3, further comprising:
identifying that the first location management client is authorized to transmit the location reporting trigger cancel request for the second location management client and the fourth location management client; and
determining the functional alias corresponding to a list of MC service identifiers (IDs) of the second location management client and the fourth location management client.

6. The method of claim 5, further comprising:
performing an event-triggered location reporting cancel procedure for the second location management client and the fourth location management client.

7. The method of claim 1, wherein the location reporting trigger cancel request includes at least one of:
an MC service ID for the first location management client;
a first functional alias corresponding to the first location management client;
an MC service ID list for location management clients whose location information reporting is to be cancelled; or
a second functional alias corresponding to the location management clients whose location information reporting is to be cancelled.

8. A location management server comprising:
at least one processor; and
at least one memory, communicatively coupled to the at least one processor, storing instructions executable by the at least one processor individually or in any combination to cause the location management server to:
receive, from a first location management client providing a first location reporting trigger for a second location management client, a location reporting trigger cancel request to deactivate a first location reporting procedure for obtaining location information of the second location management client, and
identify that the first location management client is authorized to transmit the location reporting trigger cancel request,
wherein the location reporting trigger cancel request deactivates a second location reporting procedure triggered by a third location management client providing a second location reporting trigger for the second location management client, and
wherein the first location management client and the third location management client are for an authorized mission critical (MC) service user.

9. The location management server of claim 8, wherein the instructions further cause the location management server to:
perform an event-triggered location reporting cancel procedure for the second location management client; or
update a location reporting configuration of the second location management client.

10. The location management server of claim 8, wherein the first location reporting procedure is for obtaining location information of a fourth location management client, and
wherein the second location management client and the fourth location management client share a functional alias.

11. The location management server of claim 10, wherein the location reporting trigger cancel request is limited to one MC service at a time.

12. The location management server of claim 10, wherein the instructions further cause the location management server to:
identify that the first location management client is authorized to transmit the location reporting trigger cancel request for the second location management client and the fourth location management client, and
determine the functional alias corresponding to a list of MC service identifiers (IDs) of the second location management client and the fourth location management client.

13. The location management server of claim 12, wherein the instructions further cause the location management server to:
perform an event-triggered location reporting cancel procedure for the second location management client and the fourth location management client.

14. The location management server of claim 8, wherein the location reporting trigger cancel request includes at least one of:
an MC service ID for the first location management client;
a first functional alias corresponding to the first location management client;
an MC service ID list for location management clients, location information reporting is to be cancelled; or
a second functional alias corresponding to the location management clients whose location information reporting is to be cancelled.

15. One or more non-transitory computer-readable storage media storing computer-executable instructions that, when executed by at least one processor of a location management server individually or collectively, cause the location management server to perform operations, the operations comprising:
receiving, from a first location management client providing a first location reporting trigger for a second location management client, a location reporting trigger cancel request to deactivate a first location reporting procedure for obtaining location information of the second location management client; and
identifying that the first location management client is authorized to transmit the location reporting trigger cancel request,
wherein the location reporting trigger cancel request deactivates a second location reporting procedure triggered by a third location management client providing a second location reporting trigger for the second location management client, and
wherein the first location management client and the third location management client are for an authorized mission critical (MC) service user.
